(19) United States
(12) Patent Application Publication
(10) Pub. No.: US 2022/0335416 A1
(43) Pub. Date: Oct. 20, 2022

(54) SYSTEM AND METHOD OF ASSIGNING CRYPTOGRAPHICALLY SECURED DIGITAL ASSETS TO A VERIFIED INDIVIDUAL AND LINKING ADDITIONAL USER GENERATED CONTENTS

(71) Applicant: Karmakache Social Network Inc., Vancouver (CA)

(72) Inventor: Kyrle WRIGHT, Vancouver (CA)

(21) Appl. No.: 17/719,668

(22) Filed: Apr. 13, 2022

Related U.S. Application Data
(60) Provisional application No. 63/175,804, filed on Apr. 16, 2021.

(51) Int. Cl. G06Q 20/36; H04L 9/32; H04L 9/00; G06Q 20/38

(52) U.S. Cl. CPC G06Q 20/3674; G06Q 20/363; H04L 9/3213; H04L 9/50; G06Q 20/381; G06Q 20/38215; H04L 2209/60; G06Q 2220/00

(57) ABSTRACT

A method for verifying an individual and associating a unique cryptographically secured digital asset (CSDA) with the verified individual can involve verifying the individual, creating a parent cryptographically secured digital asset for that individual, creating child CSDA's for each UGC created by the verified individual and linking the child CSDA to the parent CSDA.

### FIELD

The present disclosure relates generally to a system and method for associating cryptographically secured digital assets (CSDAs) to a verified owner and to other CSDAs. Additionally, aspects of this disclosure relate to the monetization and compensatory purposes of associating CSDAs to a verified owner and to other CSDAs.

### BACKGROUND

The market for digital assets has been growing since the creation of the internet and has achieved significant milestones. With the advances in blockchain technology and its application, digital assets may be secured as CSDAs using blockchain technology. Blockchain technology provides an open, decentralized and immutable system for data storage and processing. CSDAs, one example being Non-Fungible Tokens (NFTs), may represent a unique digital asset, store information about the digital asset, and be sold for cryptocurrency or other forms of currency.

With the cryptocurrency industry and public attention rapidly growing, there is a need for a strong verification process for identifying a creator or owner of a digital asset and to associate groups of digital assets together as digital asset families. Likewise, blockchain technology using proof of work protocols is computationally expensive and may be inefficient for some systems. Hence, there exists a need for a more efficient system and method for creating and linking digital assets.

### SUMMARY

This present invention is directed to a system and method of assigning a unique CSDA and further associated CSDAs to a verified individual. The system and method comprise identifying and verifying an individual, creating a CSDA using the individual's identifying information, linking user generated content (UGC) created by individual to the CSDA, creating child CSDAs for the UGCs.

In a broad aspect of the invention, a method for verifying and assigning a unique CSDA to an individual user involves verifying an individual user, creating a parent cryptographically secured digital asset (CSDA) for the verified user, associating one or more user generated content (UGC), created by the verified user, with the parent CSDA, by creating one or more child cryptographically secured digital asset (CSDA) for each of the one or more UGC, and linking one or more child CSDA to the parent CSDA.

### BRIEF DESCRIPTION OF THE DRAWINGS

FIG. 1 shows a flowchart of the system and method of creating and assigning a CSDA to a verified individual and associating UGCs to the CSDA;

FIG. 2 shows a flowchart of three embodiments of the invention for verifying an individual or member prior to creating and being associated to a CSDA;

FIG. 3 shows a flowchart of an embodiment of the invention where identifying information or data of an individual may be associated to a CSDA;

FIG. 4a shows an embodiment of the invention where child CSDAs are created for each UGC generated by an individual before being flagged or unflagged;

FIG. 4b shows an embodiment of the invention where the UGCs are flagged or unflagged prior to containerizing UGCs as child CSDAs;

FIG. 4c shows an embodiment of the invention where UGCs are non-containerized irrespective of having been flagged or unflagged; and

FIG. 5 shows linking of two or more CSDAs as CSDA families for compensatory purposes.

### DETAILED DESCRIPTION

The system and method of assigning a unique CSDA and further associated CSDAs to a verified individual comprise identifying and verifying an individual, creating a CSDA using the individual's identifying information, associating UGCs created by the individual to the CSDA, and creating child CSDAs for the UGCs that are linked to the original parent CSDA.

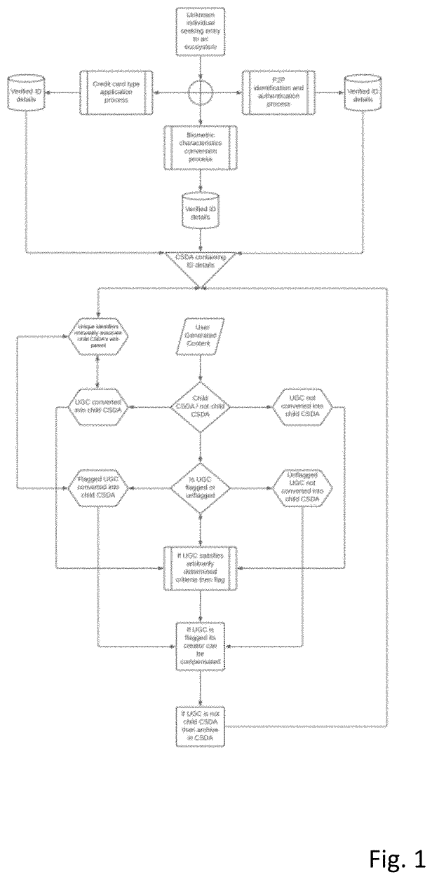

In reference to FIG. 1, an embodiment of the invention comprises identifying and verifying an unknown individual, creating a CSDA using the individual's identifying information, associating UGCs created by the individual to the CSDA, flagging certain UGCs when arbitrary parameters are satisfied, creating child CSDAs for the UGCs, and linking the child CSDAs to the original parent CSDA. A CSDA may be any cryptographically secured digital asset, for example, Non-Fungible Tokens.

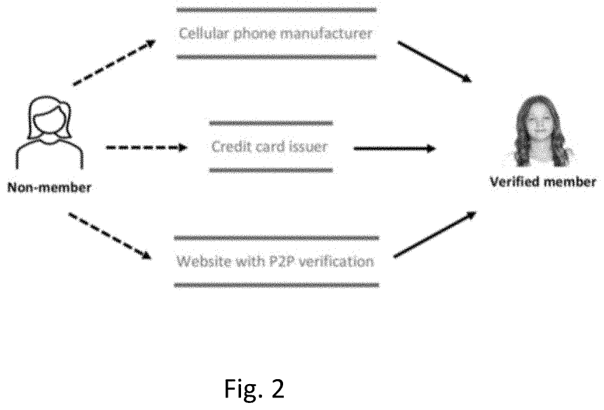

In reference to FIG. 2, an embodiment of the invention comprises identification of an unknown individual using certain metrics and identifying information, to verify an individual.

In one embodiment of the invention, biometric information may be used to verify the individual. Biometric information including, but not limited to, fingerprint and facial recognition data may be used to verify the individual. Such biometric information may be recorded and used to create a CSDA that is linked to the individual.

In another embodiment of the invention, a verification process, similar to a process for applying for a credit card, may be used to verify the individual. For such verification process, the individual is identified using methods including, but not limited to, providing personal information such as name, address, and age, running credit checks, verifying identification cards and government documents, requesting signatures, and requesting police background checks. The aforementioned verification information may be recorded and used to create a CSDA that is linked to the individual.

In another embodiment of the invention, a peer-to-peer (P2P) vetting and verification process may be used to determine the identity of the individual. In such process, the founding members of a network may invite trusted individuals to become members. Those new members similarly do likewise and organic growth proceeds in this fashion. As new members are onboarded, existing members verify arbitrarily chosen identification information. When each identification information has acquired a certain threshold value of P2P verification, it is recognized as true and when a certain compilation of these identification information has been amassed, the identity of that member is confirmed. Such P2P identification information may be recorded and used to create a CSDA that is linked to the individual.

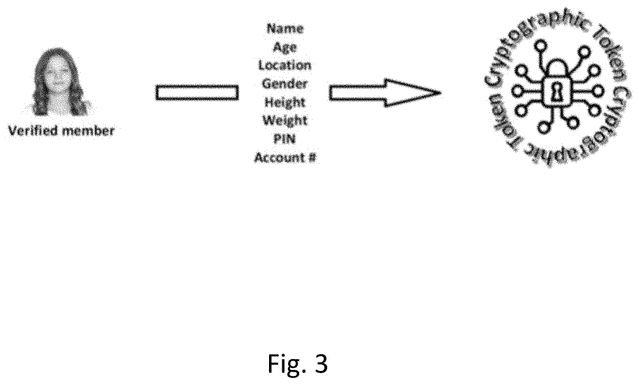

In reference to FIG. 3, an embodiment of the invention comprises creating a CSDA containing the individual's identifying information. The identifying information may include, but not limited to, name, age, location, gender, height, weight, PIN, and account number. By associating the metrics and identifying information of the individual to the CSDA, the CSDA acts as a virtual representation of the real-world individual.

In an embodiment of the invention, the CSDA may be registered to a distributed blockchain ledger which may operate on a decentralized computing system with blockchain logic.

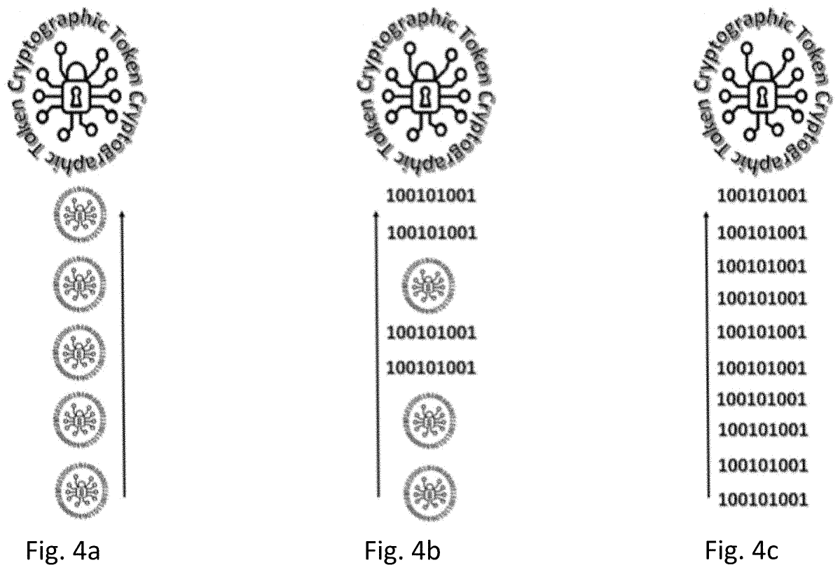

In reference to FIG. 4a) an embodiment of the invention comprises a process for linking UGCs created by the individual to an original parent CSDA. UGCs may be any content created by the individual including, but not limited to, a video, a digital artwork, a blogpost, a comment, data, and a digital recording. The UGCs may be linked to the original CSDA using cryptographic algorithms, such as the Collab Science Algorithm. In such case, the linked CSDA may be identified as a child CSDA of the original parent CSDA. The UGCs may then be flagged or unflagged based on arbitrary parameters or criteria. The parameters may measure whether the UGC is original, interesting, valuable or creative. If the UGC satisfies the parameters, then the UGC is flagged.

In an embodiment of the invention, a child CSDA that is linked to the original parent CSDA is created for each UGC created by the individual. Then, each child CSDA is classified as being flagged or unflagged based on the parameters. In this embodiment, each UGC is containerized within a child CSDA and linked to the original parent CSDA, irrespective of whether each UGC is flagged or unflagged. In an embodiment, and referring back to FIG. 1, linking of the UGC to the parent CSDA can be achieved by the use of an immutable ledger, such as a ledger database.

In reference to FIG. 4b, in an embodiment of the invention, the UGCs are first flagged or unflagged based on the parameters. In this embodiment, only the flagged UGCs are containerized within child CSDAs and unflagged UGCs are non-containerized. All UGCs are linked to the original parent CSDA, irrespective of their flagged or unflagged classification or whether they are containerized or non-containerized as child CSDAs.

In reference to FIG. 4c, in an embodiment of the invention, all UGCs are left non-containerized and linked to the original CSDA. In this embodiment, none of the UGCs are containerized into child CSDAs.

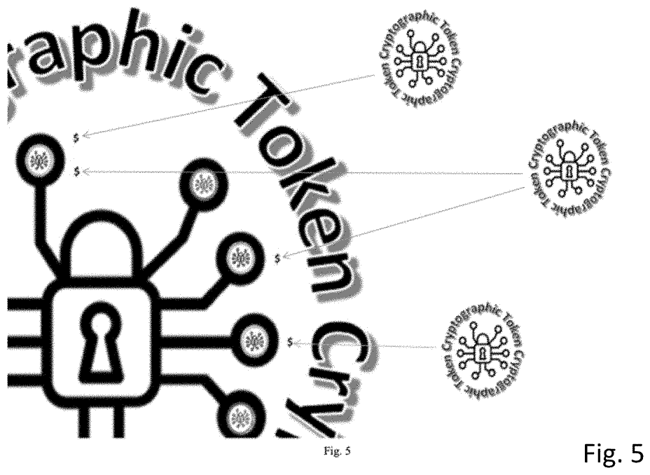

In reference to FIG. 5, in an embodiment of the invention, once UGCs are linked to the original parent CSDA, regardless of having been containerized as child CSDAs or non-containerized, a compensatory period may commence. Compensation may be conferred by anyone with access to the distributed blockchain ledger. Compensation may be in the form of physical, fiat, and or digital currency, awards, or rewards as conceived of and managed by the ownership of a CSDA.

In an embodiment of the invention, the child CSDA may act as an award for the individual. In such embodiment, if a UGC is flagged in accordance with the parameters, it will be containerized as a child CSDA and be awarded to the individual. Then, the child CSDA may then be used as a form of digital currency or digital asset.

In another embodiment of the invention, a copyright regime may be applied to the CSDA and all UGCs contained therein. Such regime may mirror pre-existing copyright laws of various jurisdictions or ad hoc strategies to particular blockchains ledgers.

For example, for illustrative purposes only, Person A has created several cartoons characters, CC1, CC2, and CC3, for a project. Person A publishes these cartoon characters as part of their public portfolio, on their social media account.

Person A can use embodiments of this invention to attribute ownership of the cartoon characters CC1, CC2 and CC3, to themselves and be compensated for their work.

In embodiments, Person A, using a local computer terminal, can enter various identification information to verify themselves, and using software, create a parent cryptographically secured digital asset (CSDA) using their identification information. In embodiments, Person A, using computer software stored on either a local storage device or in the cloud, and using a computer processor, can rely on a credit card type application process to verifying themselves. In other embodiments, Person A, using the same local computer terminal and processor, can use peer-to-peer (P2P) authentication methods to verify themselves. In other embodiments, biometric characteristics can be used to verify the individual user. In such embodiments, Person A would rely on a camera, scanner, or some other form of audio or visual recognition hardware to obtain biometic data, such as a fingerprint, facial recognition, voice recognition, etc, to verify themselves.

Once verified, Person A, using the same local computer processor, can access software, stored locally on a storage device or stored on the cloud and accessed via the internet, to create a parent CSDA using their identification information. In an embodiment, an immutable ledger, such as a ledger database, can be used to link CC1, CC2, and CC3 to the parent CSDA.

Person A can then create child CSDAs for each of CC1, CC2, and CC3, thereby associating CC1, CC2 and CC3 with Person A, and linking the child CSDAs of CC1, CC2, and CC3 with the parent CSDA.

As CC1, CC2 and CC3 are publicly available, any member of the internet can comment on each of CC1, CC2, and CC3, whether these comments are flattering, or not. Further, based on arbitrary parameters established by the members of the internet, members of the internet can flag each of CC1, CC2 and CC3. In embodiments, some examples of arbitrary parameters can include aesthetic looks, intellectual sensibilities, uniqueness of the UGC, etc. For example, members of the internet at large can like CC1, and CC3, but dislike CC2, simply based on a visual appearance of the cartoon characters and popularity.

In embodiments, members of the internet can also attribute a value to CC1 and CC3 but not CC2, as CC2 was flagged as not being popular. Further still, where applicable and permitted by the particular social media platform, members of the internet can then express their recognition and appreciation of CC1 and CC3 by completing a transaction which can include transferring at least one token of recognition to Person A. The transfer of the at least one token of recognition (or transaction) can be recorded on the blockchain and be associated with the appropriate child CSDA.

In this particular example, CC1 may be more popular, and the general public can attribute a higher value to CC1, as opposed to CC3. Accordingly, some members can complete a transaction by transferring an amount of a cryptocurrency to Person A. This transaction can be recorded on the blockchain and be associated with CC1.

In embodiments, a value of the UGC, in this case, CC1, can be determined by the number of flags received from members of the internet.

Person A then has the option to withdraw any cryptocurrency in exchange for real money using any of the know cryptocurrency wallets.

1. A method for verifying and assigning a unique CSDA to an individual comprising the steps of:
verifying an individual user;
creating a parent cryptographically secured digital asset (CSDA) for the verified user;
associating one or more user generated content (UGC), created by the verified user, with the parent CSDA by creating one or more child cryptographically secured digital asset (CSDA) for each of the one or more UGC; and
linking the one or more child CSDA to the parent CSDA.

2. The method of claim 1, further comprising publishing the one or more UGC on the internet.

3. The method of claim 2, further comprising allowing members of the public to flag each of the one or more UGC.

4. The method of claim 3, wherein allowing members of the public to flag each of the one or more UGC further comprising flagging the one or more UGC using arbitrary parameters as established by the members of the public.

5. The method of claim 4, wherein flagging the one or more UGC further comprises the members of the internet attributing a value to the one or more flagged UGC.

6. The method of claim 5, wherein attributing a value to the one or more flagged UGC further comprises completing a transaction by transferring at least one token of recognition to the verified user.

7. The method of claim 6, wherein completing a transaction further comprises recording the transfer of the at least one token of recognition to the verified user on the blockchain.

8. The method of claim 7 further comprising associating the transaction with the child CSDA of the one or more UGC.

9. The method of claim 8 further comprising the verified user converting the at least one token of recognition into real currency.

10. The method of claim 1, wherein verifying the individual user further comprises verifying the individual user using a credit card type application process, a peer-to-peer (P2P) identification and authentication process, or a biometric characteristic conversion process.

11. The method of claim 1, wherein associating one or more UGC to the parent CSDA further comprises the use of an immutable ledger.

12. The method of clam 11, wherein the immutable ledger further comprises a ledger database.
